(19) United States
(12) Patent Application Publication
(10) Pub. No.: US 2013/0007644 A1
(43) Pub. Date: Jan. 3, 2013

(54) PROFILING SYSTEM, PROFILING METHOD AND RECORDING MEDIUM

(75) Inventors: Satoru Ooga, Tokyo (JP); Asako Miura, Nishinomiya-shi (JP)

(73) Assignee: NEC CORPORATION, Tokyo (JP)

(21) Appl. No.: 13/634,134

(22) PCT Filed: Mar. 4, 2011
(86) PCT No.: PCT/JP2011/055145

§ 371 Date: Sep. 11, 2012

(30) Foreign Application Priority Data
Mar. 12, 2010 (JP) 2010-055978

(51) Int. Cl. G06F 3/048

(52) U.S. Cl. 715/764

(57) ABSTRACT

A GUI part selector 13, on the basis of background information received from a question controller 11 and GUI information retrieved from a GUI storage 14, generates background/GUI-related information, and generates an output determination table on the basis of the condition of the respondent as determined by a user determinator 15. The GUI parts selector 13, on the basis of the output determination table, selects GUI parts information used in the display of question information corresponding to the background information received by the question controller 11. An output screen generator 16 generates an output screen using the GUI parts information selected by the GUI part selector 13, and the question information received by the question controller 11 and transmits it to a respondent terminal 6.

### TECHNICAL FIELD

The present invention relates to a profiling system for performing a profile of a respondent, a profiling method and a recording medium, and has the objective of extracting the profile of a respondent.

### BACKGROUND ART

Methods for examining results relating to some type of external stimulus and individual profiles, for example, or so-called character or nature profiles, include psychological questionnaires. These are used for the purpose of analyzing/predicting daily human behavioral (mechanical operations, and human interactions and the like) tendencies. In order to do so, extraction of accurate and precise reactions are sought from individuals. The questionnaires used in such examinations and surveys are those which generally exist or questionnaires newly created by individuals creating the questions. In other words, the question creators have a pre-determined condition which they want to know something about, and create questionnaires designed to elicit an accurate response.

At the same time, the question creator, in executing the questions, seeks to prevent the respondent from failing to provide an accurate response because of the influence of noise. For example, in a noisy room, there is high possibility that the surrounding sound will become bothersome, with a drop in response accuracy connected to the disrupted attention of the respondent. The same is true of an environment where there is disrupting visual stimulation from video images and the like entering the eyes, and an attempt is made to remove the external accuracy-reducing factors at the time of the examination/survey.

In addition, bias when responding is a factor that reduces accuracy. For example, if someone sees his own name, a person may become self-conscious, and a so-called “social bias” to show oneself well, if even slightly, can act unconsciously. By this means, cloaking oneself, and making oneself socially acceptable makes the selection of a response easy. Otherwise as well, if the examination/survey is thought to be a trial, if shown the remaining number of questions, an “end bias” promotes the desire to quickly complete the examination process. Since the individual differences exist, there are individuals who are strongly influenced, and individuals who are not influenced very much. Conversely, there are also individuals who are motivated to endure to the end. Preventing such complex influences from changing the response is vital in administering examination/surveys, and with paper questionnaires, an effort is made to remove influences which might produce negative stimulation, by not showing anything to the individual being tested.

On the other hand, recently, in comparison with paper questionnaires, a style of executing questions in a personal computer environment has quickly spread, which focuses on the Web and is extremely useful from the standpoint of superiority in terms of labor/costs, or easily accumulating or totaling responses.

In Patent Literature 1, a survey system is disclosed that creates survey pages to which the respondent can easily reply by changing combinations of multiple selection arms comprising the response candidates for questions corresponding to the individual information of the respondent. The survey system of Patent Literature 1 is a survey system which executes the survey questionnaire through a communications network.

In Patent Literature 2, reference is made to a data processing method of psychological survey results in which the results of the psychological questionnaire are made visual by group dividing data having a similar inclination, realizing numerically valued responses and numerically valued results of the respondent obtained through the execution of a psychological questionnaire in a survey format by means of different hues or shades of color, used for color conversion (colorization) corresponding to the numerical size.

Since, by this means, the examination/surveys can be quickly executed at low cost, and the computer style can be immediately changed thereafter, there is high probability of their coming into general use in lieu of paper questionnaires.

In addition, Patent Literature 3 discloses an interface system in which the user interface of an application program can be appropriately applied corresponding to the state of an individual or computer system.

Patent Literature 4 discloses a user interface generation device which administers a survey set by the GUI (Graphical User Interface), determines the user category, and applies the GUI display for the category, based on the analysis results.

Patent Literature 5 discloses a method of expressing significant areas in which an objective evaluation of the significant areas and information processing ability of an individual are expressed by intersecting three-dimensional graphs in which the evaluation values determined by significant area keywords, psychological relationship to the evaluator, and the evaluator oneself become the axes. In Patent Literature 5 reference is made to adding a social bias to the evaluation value.

### PRIOR ART LITERATURE

### Patent Literature

Patent Literature 1: Unexamined Japanese Patent Application Kokai No. 2005-209042
Patent Literature 2: Unexamined Japanese Patent Application Kokai No. 2008-148798
Patent Literature 3: Unexamined Japanese Patent Application Kokai No. 2000-330676
Patent Literature 4: Unexamined Japanese Patent Application Kokai No. 2006-004054
Patent Literature 5: Unexamined Japanese Patent Application Kokai No. H09-044470

### DISCLOSURE OF THE INVENTION

### Problems to be Solved by the Invention

However, in comparison with the case of using a dedicated computer, in a respondent's handling of questions through a well used PC (Personal Computer), the information (name or time and the like) output daily by the OS (Operating System) can be easily inspected. By this means, there is the problem that biases may occur which are not desired by the questions' creator. Therefore, the submitted information is necessarily controlled to prevent reduction in response accuracy caused by biases at the time of response by the respondent.

On the other hand, in laboring to reduce the uneasiness relating to confirmation on the part of the respondent or in order to avoid errors in operation, there are times when it is necessary to present the equipment in an operational state. For example, there is a possibility of problems occurring in operator responses because of errors in the respondent's name or storage problems because of poor conditions in the system. It is important to communicate in order to avoid creating problems such as burdens or uneasiness on the part of the respondent, while ensuring that there are no undue concerns. By removing such uneasiness, a collected response can be anticipated.

In electronic profiling performed through a PC used daily by a respondent, it is desirable to confirm the name of the respondent is performed at the beginning of the questioning stage, to present the actions of the system and to present questions for which biases can be suppressed at the time of questioning.

The survey system described in Patent Literature 1 controls information presented on the output screen, and does not prevent the reduction of response accuracy caused by bias at the time of response by the respondent.

The invention described in Patent Literature 2 is a data processing method of psychological examination results, and is not an invention concerning technology for executing psychological examination in a survey format.

The invention described in Patent Publication 3 is a method for creating the user interface of an application program, but there is nothing suggested in the notation concerning technology for reducing a bias in the user interface at the time of administering a survey on a PC.

The survey in the invention described in Patent Literature 4 is a survey for determining the respondent category for setting the GUI, and is not a profiling survey. In addition, there is also nothing suggested concerning technology for reducing a bias in a user interface which administers a survey on a PC.

The method of expressing the significant area recorded in Patent Literature 5 does not control the information provided on an output screen.

The present invention was achieved in view of the above problems. An objective of the present invention is to provide a profiling system, a profiling method and a recording medium that can generate an output screen which reduces the respondent's bias due to GUI parts in profiling in which questions which are used to examine the nature of the respondent are submitted to the respondent and the responses are acquired.

### Means for Solving the Problems

A profiling system relating to the first point of view of the present invention includes:

question storage means which stores question information showing a question for examining a nature of a respondent and background information showing a relationship between a background intent showing the nature and a bias which exerts an influence on responses of the respondent;

GUI storage means which stores GUI information showing a relationship between GUI parts which are elements composing an output screen and the bias;

selection means which, based on the background information and the GUI information, calculates a degree of influence of the bias by pairing the background intent with the GUI parts, and which selects GUI parts information where the degree of influence exceeds a threshold value; and

presentation means which creates the output screen based on the question information and the GUI parts information selected by the selection means to present the output screen to the respondent.

A profiling method relating to the second point of view of the present invention is a profiling method performed by a profiling system which submits questions to a respondent, the method includes:

a selection step which, based on background information showing a relationship between a background intent showing a nature of a respondent examined by the question and a bias exerting an influence on a response of the respondent, the background information being stored by question storage means, and GUI information showing a relationship between GUI parts which are elements composing an output screen and the bias, the GUI information being stored by GUI storage means, calculates a degree of influence of the bias by pairing background the intent and the GUI parts and selects GUI parts information which has the degree of influence that exceeds a threshold value; and

a presentation step which, based on question information showing the questions and the GUI parts information selected in the selection step, generates the output screen and presents the output screen to the respondent.

A computer-readable recording medium relating to the third observation point of the present invention, records a program for causing a computer to perform

a selection step which, based on background information showing a relationship between a background intent showing a nature of a respondent examined by the question and a bias exerting an influence on a response of the respondent, the background information being stored by question storage means, and GUI information showing a relationship between GUI parts which are elements composing an output screen and the bias, the GUI information being stored by GUI storage means, calculates a degree of influence of the bias by pairing background the intent and the GUI parts and selects GUI parts information which has the degree of influence that exceeds a threshold value; and

a presentation step which, based on question information showing the questions and the GUI parts information selected in the selection step, generates the output screen and presents the output screen to the respondent.

### Efficacy of the Invention

According to the present invention, in profiling which electronically administers questions through a PC used daily by a respondent, an output screen can be generated which reduces the bias of the respondent by GUI parts. By this, prevention of the reduction of response accuracy caused by the respondent's biases the time of response can be anticipated.

### BRIEF DESCRIPTION OF DRAWINGS

FIG. 1 is a block diagram showing a compositional example of the profiling system relating to embodiment 1 of the present invention;

FIG. 2 is a diagram explaining the data of question background information stored in question/background storage in embodiment 1;

FIG. 3 is a diagram explaining the data composition of the background information stored in the question/background storage in embodiment 1;

FIG. 4 is a diagram explaining the data composition of the GUI information stored in the GUI storage in embodiment 1;

FIG. 5 is a diagram explaining the data composition of background/GUI related information generated by the GUI parts selector in embodiment 1;

FIG. 6 is a diagram explaining the data composition of the output determination table generated by the GUI parts selector in embodiment 1;

FIG. 7 is a diagram showing an example of background information stored in question/background storage in embodiment 1;

FIG. 8 is a diagram showing an example of GUI information stored in GUI storage in embodiment 1;

FIG. 9 is a diagram showing an example of background/GUI related information generated by the GUI parts selector in embodiment 1;

FIG. 10 is a diagram showing an example of an output determination table generated by the GUI parts selector in embodiment 1;

FIG. 11 is a diagram explaining an example of an arrangement of GUI parts information in the output screen relating to embodiment 1;

FIG. 12 is a diagram explaining an example of an output screen relating to embodiment 1;

FIG. 13 is a flowchart showing an example of profiling action relating to embodiment 1.

FIG. 14 is a flow chart showing an example of the action of the GUI parts selection process relating to embodiment 1;

FIG. 15 is a block diagram showing a compositional example of a profiling system relating to embodiment 2 of the present invention;

FIG. 16 is a diagram explaining the data composition of an output determination table generated by the GUI parts selector in embodiment 2;

FIG. 17 is a diagram explaining an example of an output screen relating to embodiment 2;

FIG. 18 is a flowchart showing an example of the action of the GUI parts selection process relating to embodiment 2; and

FIG. 19 is a block diagram showing an example of the hardware composition of the profiling device relating to an embodiment of the present invention.

### MODE FOR CARRYING OUT THE INVENTION

In the present invention, question information is information showing questions created by the individual creating the questions. A background intent is the objective nature examined by the questions. The background intent, in most cases, is not usually explicitly indicated in the questions, but may, however, occasionally be explicitly indicated in a question. Background intent information is information showing background intent. Question background information is information showing the type of background intent which is included in question which is shown by each question information. Moreover, in question information, identification information, which identifies the question information, is applied. Bias is an element which biases psychological factors of the respondent influencing the response towards a specific direction. Bias information is information showing a bias, and includes information relating to the factors and bias direction. Background information is information showing the relationship between background intent and bias. Background intent includes measurement of skill, information acquisition and personal idiosyncrasies and the like. Bias includes social bias and end bias.

The GUI is a user-interface which provides intuitive operation through the use of computer graphics and a pointing device. In the present invention, the GUI is the output screen. GUI parts are the elements composing the output screen. GUI parts information is information showing the GUI parts. GUI information is information showing the relationship between the GUI parts and bias. The GUI parts include name information showing the name of the respondent, identification information which identifies the question information, date and time information showing the current date and time and progress information showing the current state of progress relative to all of the questions.

A detailed explanation concerning an embodiment for executing the present invention is provided hereafter, with reference to the drawings. Furthermore, parts corresponding to the same parts in the drawings are labeled the same.

### Embodiment 1

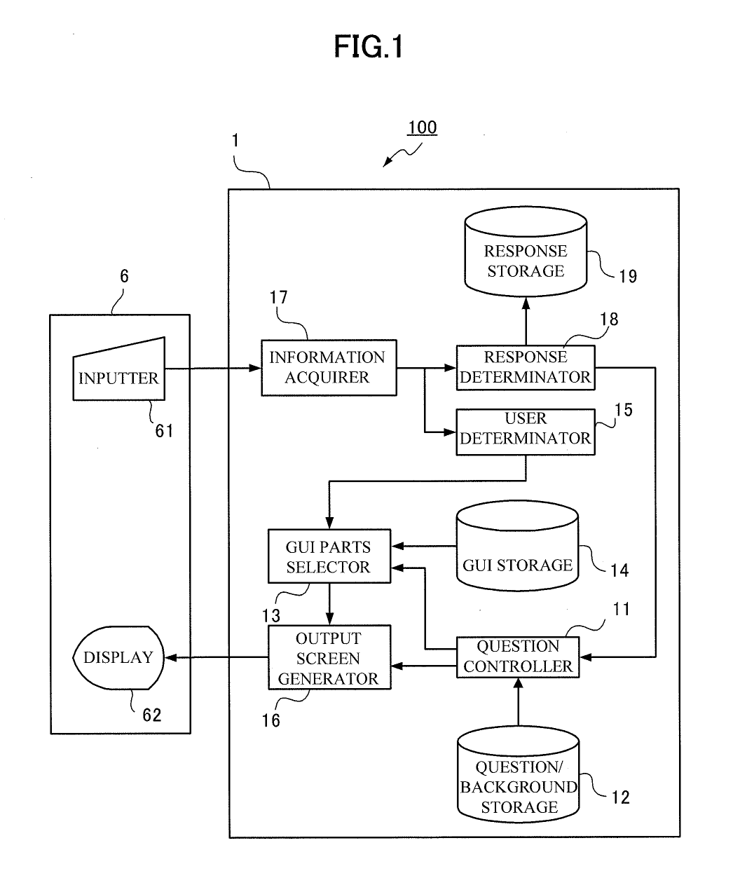

FIG. 1 is a block diagram showing a compositional example of the profiling system relating to embodiment 1 of the present invention. A profiling system 100 comprises a profiling device 1 and respondent terminal 6. The profiling device 1 and the respondent terminal 6 are mutually capable of communication through a network, (not shown in the diagram). The respondent terminal 6 is represented by the single unit shown in the diagram. However, multiple respondent terminals 6 may be connected to the network. In addition, the respondent terminal 6 may be a part of the profiling device 1, or may be an attached device.

The profiling device 1 includes a question controller 11, question/background storage 12, GUI parts selector 13, GUI storage 14, user determinator 15, output screen generator 16, information acquirer 17, response determinator 18 and response storage 19. The question/background storage 12, GUI storage 14 and response storage 19 may be configured by devices which are separately connected to the profiling device 1 through the network. The respondent terminal 6 includes an inputter 61 and display 62.

The question controller 11 controls which question information is submitted next to the respondent. The question controller 11 retrieves the question information and background information accumulated in the question/background storage 12, and sends in sequential output order the question information to the output screen generator 16. At this time, the question controller 11 sends background information which includes the same background intent information as the background intent information corresponding to the question information to the GUI parts selector 13. The question controller 11 may send the question information to the output screen generator 16 when the information acquirer 17 of the profiling device 1 acquires the question submission request input by the respondent to the inputter 61 of the respondent terminal 6. The question controller 11 may also send the question information to the output screen generator 16 in accordance with a pre-arranged schedule.

The question/background storage 12 stores question information and background information. In addition, the question/background storage 12 also stores question background information showing the type of background intent behind the question shown by each question information.

The GUI parts selector 13 generates the background/GUI related information showing the relationship between the background intent information and GUI parts information based on the background information received from the question controller 11 and GUI information retrieved from the GUI storage 14. Also, the GUI parts selector 13 generates an output determination table based on the background/GUI related information and the value such as the degree of fatigue or stress received from the user determinator 15. The GUI parts selector 13 selects the GUI parts information used in a display based on the output determination table. The GUI parts selector 13 sends the selected GUI parts information to the output screen generator 16. The background/GUI related information and output determination table may be pre-established.

The GUI storage 14 pre-stores the GUI parts information and GUI information.

The user determinator 15 determines the conditions of the respondent based on input information received from the information acquirer 17. In addition, the user determinator 15 sends the determined condition of the respondent to the GUI parts selector 13 as the value such as the degree of fatigue or stress.

The output screen generator 16 generates an output screen using question information received from the GUI parts information received from the GUI parts selector 13 and the question information received from the question controller 11 and sends the output screen to respondent terminal 6.

The information acquirer 17 receives the input information from the respondent terminal 6. The information acquirer 17 sends the input information necessary for determining the condition of the respondent to the user determinator 15, and sends the input information showing the response results to the response determinator 18.

The response determinator 18 determines which question the response relates to, in relation to the response results included in the input information, correlates the response results to the question information, and stores the response results in the response storage 19. Moreover, if the response is deficient, information showing the response to be deficient may be sent to the question controller 11, and the question controller 11 may re-output the question information.

The response storage 19 stores the response results relative to the question information.

The inputter 61 of respondent terminal 6 receives the response of the respondent, and sends the input information to the profiling device 1. The inputter 61, in addition to acquiring, the input information showing the response relating to the questions may acquire biometric information of the respondent at the time of response, and may send the biometric information to the profiling device 1. In this case, the user determinator 15 of the profiling device 1 determines the condition of the respondent based on the input information and/or biometric information. The inputter 61 may be a mouse, keyboard, audio input device or camera. The inputter 61, when acquiring the biometric information, may use, for example, a perspiration sensor or myogenic potential sensor. The display 62 displays the output screen sent from the output screen generator 16 of the profiling device 1.

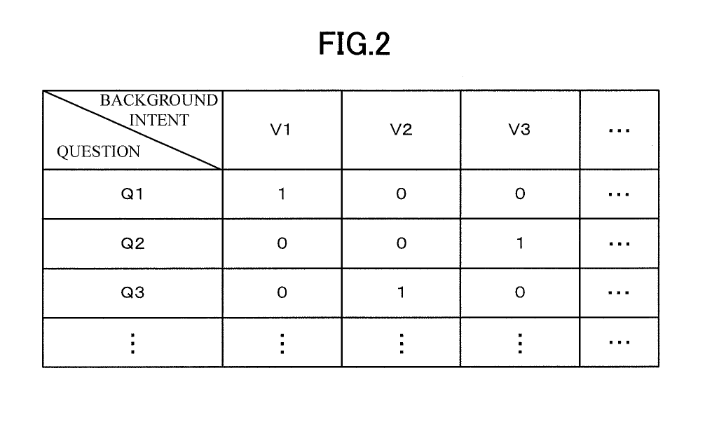

FIG. 2 is a diagram which explains the data composition of question background information stored in the question/background storage 12 in embodiment 1. The question background storage 12 stores the data table shown in FIG. 2 as question background information. The question/background information comprises the question information and background intent information.

Background intent information is information showing the nature desirous of being acquired by the question creator with question information. For example, if the question information shows a question for measuring the skill of the respondent, the background intent information shows “skill measurement”. If the question information shows a question for determining performance, the background intent information shows “performance measurement”. If the question information shows a question for eliciting a past career or past facts, the background intent information shows “information acquisition”. If the question information shows a question for eliciting a psychological response internal to the individual, the background intent information shows “individually internal”. If the question information shows a question for eliciting the nature of personal activities, the background intent information shows “personal nature”. If the question information shows a question for eliciting the nature of behavior within a group or to group behavior, the background intent information shows “group nature”. If the question information shows a question for examining reaction at the time of stress, the background intent information shows “stress nature”. If the question information shows a question for examining people skills, the background intent information shows “social extroversion”. In the example of FIG. 2, question information is referred to as ID (Q1, Q2, Q3 . . . ) which identifies each question information, and background intent information is referred to as ID (V1, V2, V3 . . . ) which identifies each background intent information.

Question background information is information showing what kind of background intent exists in a question shown by each question information. In an example of FIG. 2, the value of the background intent information showing the background intent existing in a question shown by the question information is 1, and the value of background intent information having no relationship is zero. For example, since the question of question information Q1 has the background intent shown by the background intent information V1, 1 is recorded in the Q1/V1 box. In the same manner, the question of question information Q2 has the background intent shown by background intent information V3, and since the question of question information Q3 has the background intent shown by background intent information V2, 1 is recorded in respective boxes Q2/V3 and Q3/V2. Moreover, the value recorded in the box may be weighted using an intermediate value. The question/background storage 12 pre-records this type of question background information. A single item of question information may be related to multiple items of background intent information.

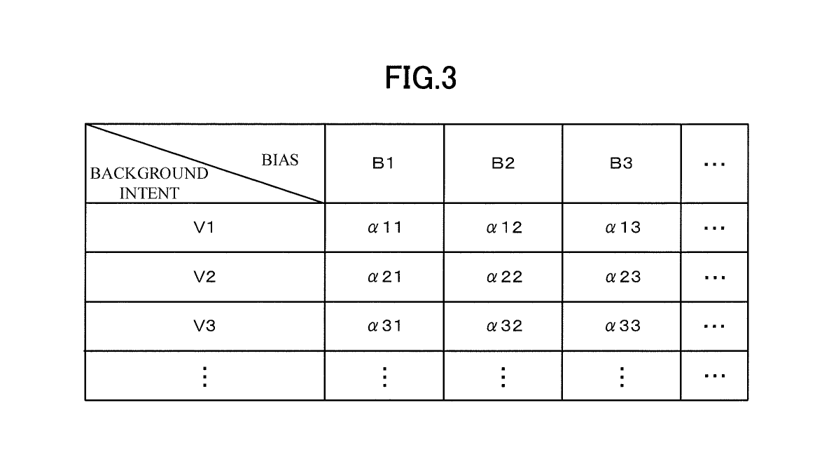

FIG. 3 is a diagram which explains the data composition of background information stored in the question/background storage 12 in embodiment 1. The question/background storage 12 stores a data table shown in FIG. 2 as background information. Background information comprises background intent information and bias information.

Background information is information showing the type of bias by which each background intent is influenced. As shown in FIG. 3, background information can be expressed in a matrix αij such that the value of the V1/B1 box is α11, and V1/value of the B2 box is α12. The αij is a value showing the extent to which influence by bias information Bj is received when background intent information Vi exists. The αij is pre-applied. The question/background storage 12 pre-stores this type of background information. In the example of FIG. 2, bias information is recorded as ID (B1, B2, B3 . . . ), which identifies each bias information.

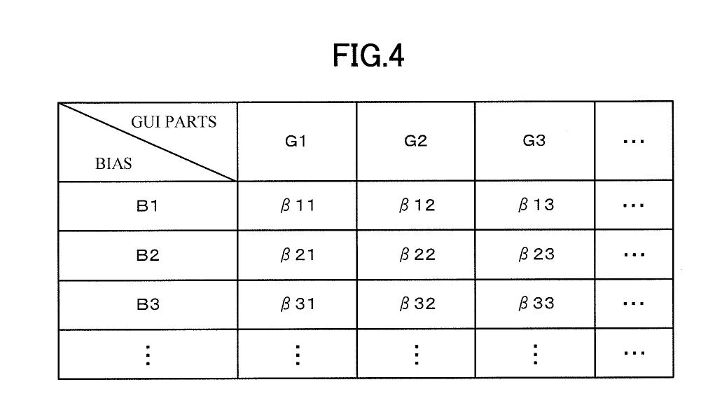

FIG. 4 is a diagram which explains the data composition of the GUI information stored in the GUI storage 14 in embodiment 1. The GUI storage 14 stores a data table shown in FIG. 4 as GUI information. The GUI information comprises GUI parts information and bias information. The GUI parts information is information showing the GUI parts information composing an output screen, such as name information, identification information, date and time information, and progress information. In the example of FIG. 4, the GUI parts information is recorded as an ID (G1, G2, G3 . . . ) which identifies each GUI parts information.

The GUI information is information showing the type of bias generated by each GUI part. As shown in FIG. 4, the GUI information can be expressed in a matrix βjm such that the value of B1/G2 box is β11, and the value of B1/G2 box is β12. The βjm is a value showing the extent to which GUI parts information Gm generates bias information βj. The βjm is pre-set. The GUI storage 14 pre-stores this type of GUI information.

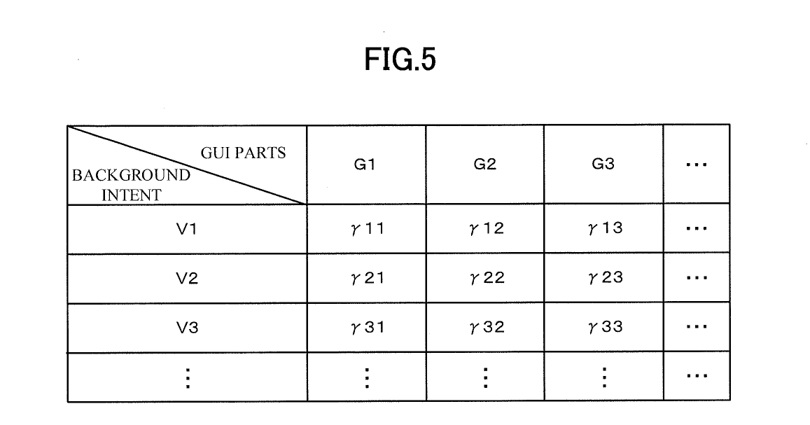

FIG. 5 is a diagram which explains the data composition of the background/GUI related information generated by the GUI parts selector 13 in embodiment 1. The GUI parts selector 13 generates the background/GUI related information based on the background information received from the question controller 11 and the GUI information retrieved from GUI storage 14. The background/GUI related information shows the type of relationship the GUI parts information has with the background intent information, and shows the extent to which the influence of a bias is received in the combination of GUI parts information and background intent information. As shown in FIG. 5, the background/GUI related information can be expressed in a matrix γim such that the value of the V1/G1 box is γ11, and the value of the V1/G2 box is γ12. The γim shows the extent of bias influence when Vi and Gm are combined.

Specifically, the GUI parts selector 13 calculates:

$$\begin{matrix} ( Formula 1 ) & \\ γ i m = {\sum }_{k}^{ } α i k \cdot β km & ( 1 )\end{matrix}$$

based on the background information (matrix αij) received from the question controller 11 and the GUI information (matrix βjm) retrieved from the GUI storage 14.

An explanation is provided hereafter concerning the condition of the respondent determined by the user determinator 15. For example, in the case where the background intent information shows “personal nature”, the respondent is likely to give a cloaked response to present himself well due to a strong influence exerted by a social bias when he looks at his own name. In other words, the negative influence is likely to be exerted. Therefore, in the case of measuring “personal nature”, it would be desirable for the GUI parts information of the name information having the influential power of a “social bias” not to be displayed. On the other hand, for example, when the respondent is fatigued, he is more conscious of himself by looking at his name. Therefore, a positive influence can be anticipated by suppressing terminal bias of giving a cursory response due to his fatigue. In such cases, it is desirable to display the GUI parts information. The condition of the respondent such as fatigue are determined by the user determinator 15, and sent to the GUI parts selector 13 as the value Xn.

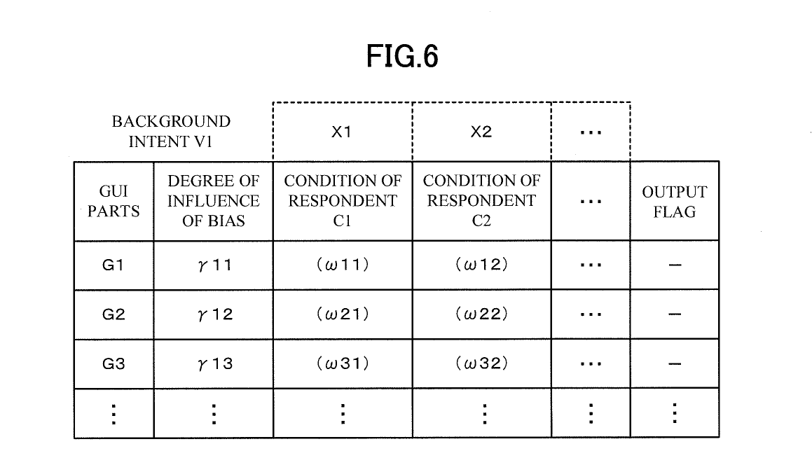

FIG. 6 is a diagram which explains the data composition of the output determination table generated by the GUI parts selector 13 in embodiment 1. The GUI parts selector 13 generates an output determination table based on the background/GUI related information (matrix γim) and the value Xn representing the condition of the respondent determined by the user determinator 15. The output determination table is generated for each background intent information, and comprises the items such as “degree of bias influence”, “respondent condition C1”, “respondent condition C2” . . . and “output flag” which are related to the GUI parts information. The GUI parts selector 13 inputs the degree of bias influence to the item “degree of bias influence” in the case of combining the background intent information and the GUI parts information, while referring to the background/GUI related information shown in FIG. 5. In the example of FIG. 6 is shown an output determination table of background intent information V1, in which the degree of bias influence γ11, γ12, γ13 . . . is input to each item “degree of bias influence” of the GUI parts information G1, G2, G3 . . . in the case of combining the background intent information V1 and the GUI parts information G1, G2, G3 . . . .

In the items “respondent condition C1”, “respondent condition C2” . . . , a coefficient of the value Xn received from the user determinator 15 is pre-set in each box. The coefficient can be expressed in a matrix ωMn such that the value of box G1/C1 is ω11, and the value of box G1/C2 is ω12. The GUI parts selector 13 receives the value Xn from the user determinator 15 and inputs ωmnxXn to each box. Concerning GUI parts information Gm, if the totaled value (γm1+ωm1xX1+ωm2xX2 . . . ) of the value input to each of the items “degree of bias influence”, “respondent circumstance C1”, “respondent circumstance C2” . . . exceeds a threshold (for example 0), the GUI parts selector 13 inputs 1 to item “output flag” and outputs the GUI parts information Gm. On the other hand, if the totaled value is less than the threshold value (for example 0), the GUI parts selector 13 inputs to item “output flag” and does not output the GUI parts information Gm.

The value of ωmn is pre-calculated and set such that the totaled value (γm1+ωm1xX1+ωm2xX2 . . . ) of the values input to each of the items “degree of bias influence”, “respondent condition C1”, “respondent condition C2” becomes 0 when the influence of the bias is determined to be 0 by offsetting the bias with the condition of the respondent.

Moreover, the background/GUI related information and output determination table may also be pre-set. In this case, the GUI parts selector 13 inputs a value obtained by multiplying the value Xn such as the degree of fatigue or stress received from the user determinator 15 by a preset coefficient ωmn to each box “respondent circumstance C1”, “respondent circumstance C2” . . . , and can be performed by only determining whether the total value of the values input to each item of the GUI parts information Gm exceeds a threshold value.

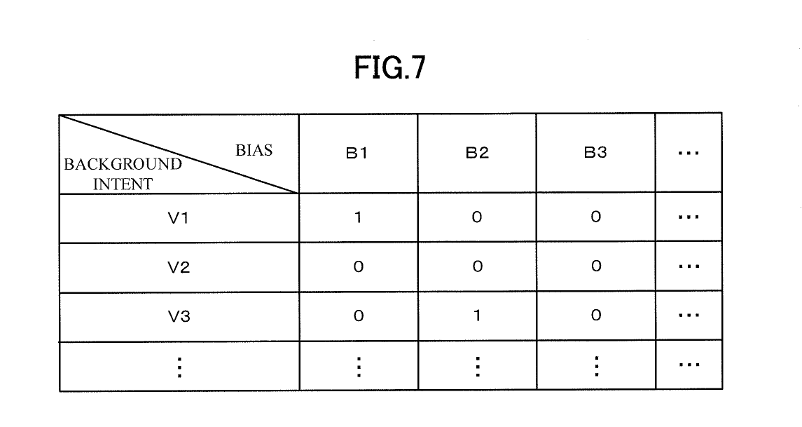

FIG. 7 is a diagram showing an example of background information stored by the question/background storage 12 in embodiment 1. In an example of FIG. 7, the αij is normalized to the value of 0, or 1. In other words, the value of bias information influencing background intent information is recorded as 1, and the value of unrelated bias information is recorded as 0. For example, in the case of background intent information V3 “skill measurement”, a bias derived from fatigue such as bias information B2 “terminal bias” has a negative influence on the response results. Therefore, 1 is input to the box V3/B2. In this manner, parts shown in the background information of FIG. 7 shows that background intent information V1 is influenced by bias information B1, and background intent information V3 is influenced by bias information B2.

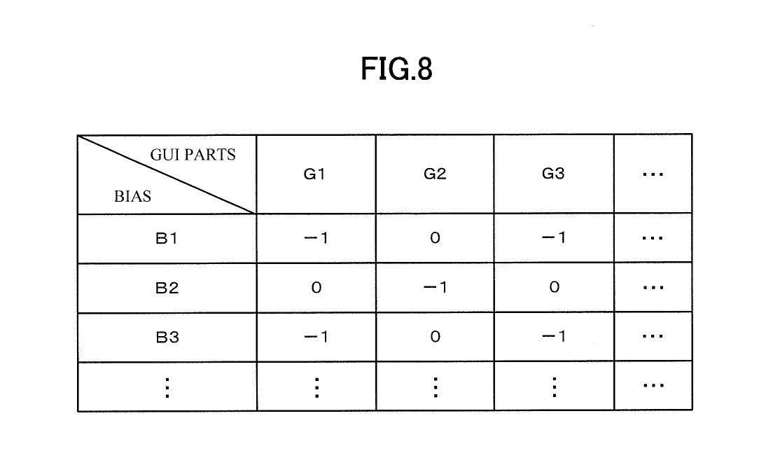

FIG. 8 is a diagram showing an example of GUI information stored by the GUI storage 14 in embodiment 1. In the example of FIG. 8, the βjm is normalized to the value 0 or −1. In other words, the value of bias information which may be caused by the GUI parts information is recorded as −1, and the value of unrelated bias information is recorded as 0. For example, GUI parts information G1 corresponding to name information may cause bias information B1 “social bias” such that the respondent becomes self-aware and shows himself as well as possible when he sees his own name. Therefore, 1 is input to the box G1/B1. In this manner, part of the GUI information shown in FIG. 8 shows that GUI parts information G1 may cause bias information B1 and B3, GUI parts information G2 may cause bias information B2, and GUI parts information G3 may cause bias information B1 and B3. Moreover, the value of bias information which may be caused by GUI parts information is set to −1 as a negative value. However, if a bias has both positive and negative directions, and for example, the desire to show himself well is defined as the “negative value of a social bias”, the desire to present oneself poorly would be a positive value. The βjm may be set considering such bias directions.

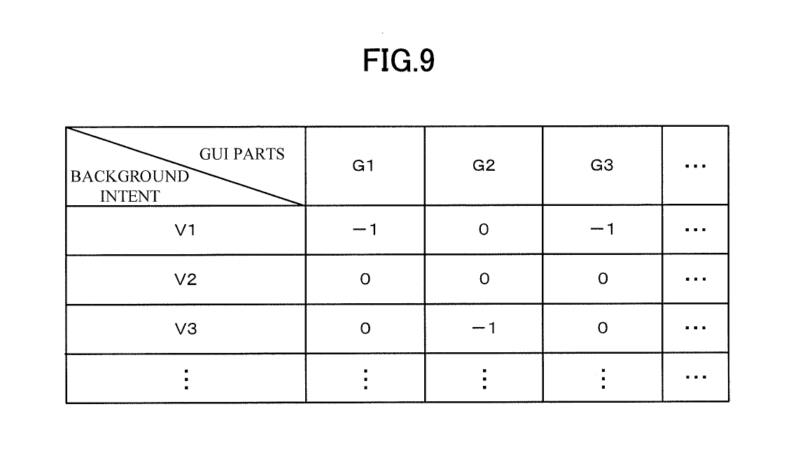

FIG. 9 is a diagram showing an example of background/GUI related information generated by the GUI parts selector 13 in embodiment 1. In the example of FIG. 9, the γim is normalized to the value 0 or −1. In other words, where there is bias influence in the case of combining background intent information Vi and GUI parts information Gm, a degree of influence −1 is recorded, and where there is no bias influence, 0 is recorded. In this manner, a part of the background/GUI related information shown in FIG. 9 shows that, in combination of background intent information V1 and GUI parts information G1; background intent information V1 and GUI parts information G3; and background intent information V3 and GUI parts information G2, the degree of influence of the bias is −1, and in other combinations, there is no received bias influence.

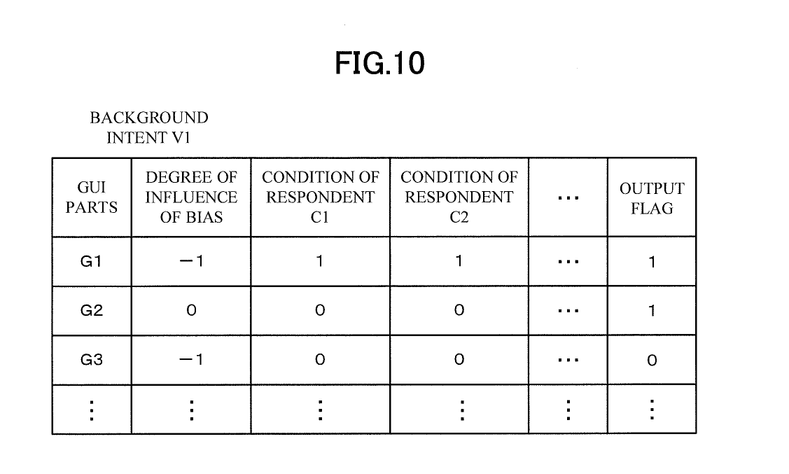

FIG. 10 shows an example of an output determination table generated by the GUI parts selector 13 in embodiment 1. In the example of FIG. 10, the possibility of outputting GUI parts information Gm related to background intent information V1 is shown. Concerning background intent information V1, the GUI parts selector 13 inputs a value to the “degree of bias influence” of the output determination table, with reference to the background/GUI related information shown in FIG. 9. In addition, the GUI parts selector 13 inputs the normalized value for ωmnxXn as a 0 or 1 to each box when the GUI parts selector 13 receives the value Xn from the user determinator 15.

Next, the GUI parts selector 13, makes a selection as to whether to output the GUI parts information Gm. Concerning the GUI parts information G1, −1+1+1≧0, then 1 is input to item “output flag”. Concerning the GUI parts information G2, 0+0+0=0≧0, then 1 is input to item “output flag”. Concerning the GUI parts information G3, −1+0+0=−1<0, then 0 is input to item “output flag”. The GUI parts selector 13 performs this type of process and generates the output determination table, and selects the GUI parts information to display.

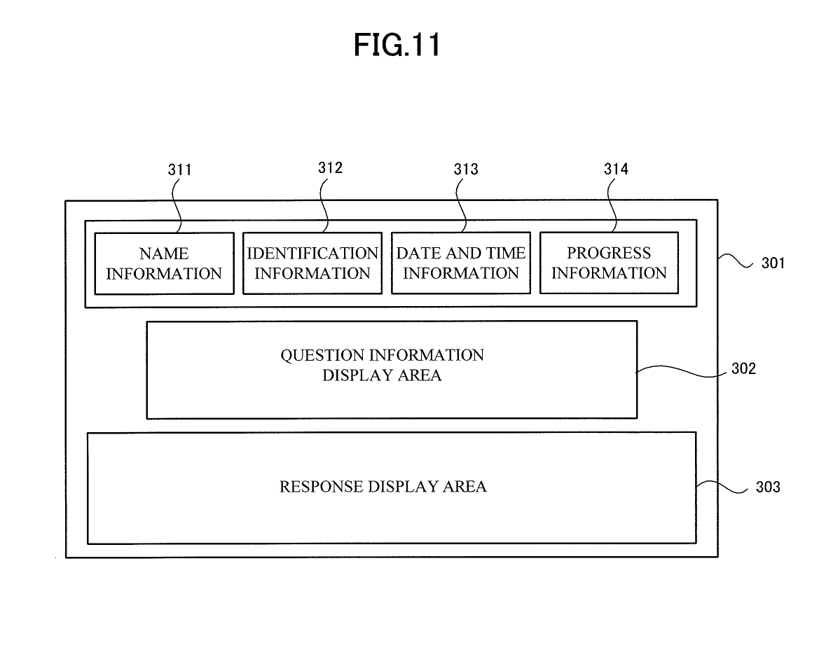

FIG. 11 is a diagram which explains an example of an arrangement of the GUI parts information in the output screen output to the display 62 of the respondent terminal 6 relating to embodiment 1. In the example of FIG. 11, the GUI parts information showing the name information, identification information, date and time information and progress information is arranged in the upper part of an output screen 301. In a name information display area 311, the name of the respondent is displayed. In an identification information display area 312, identification information which identifies question information is displayed. In a date and time information display area 313, the current date and time is displayed. In a progress information display area 314, the current progress situation relating to all of the questions is displayed. In the middle part of the output screen 301, a question information display area 302 is arranged. In the lower part of the output screen 301, a response display area 303 is displayed. In the question information display area 302, the contents of the question information is displayed. In the response display area 303, the GUI parts information such as buttons for inputting responses is displayed.

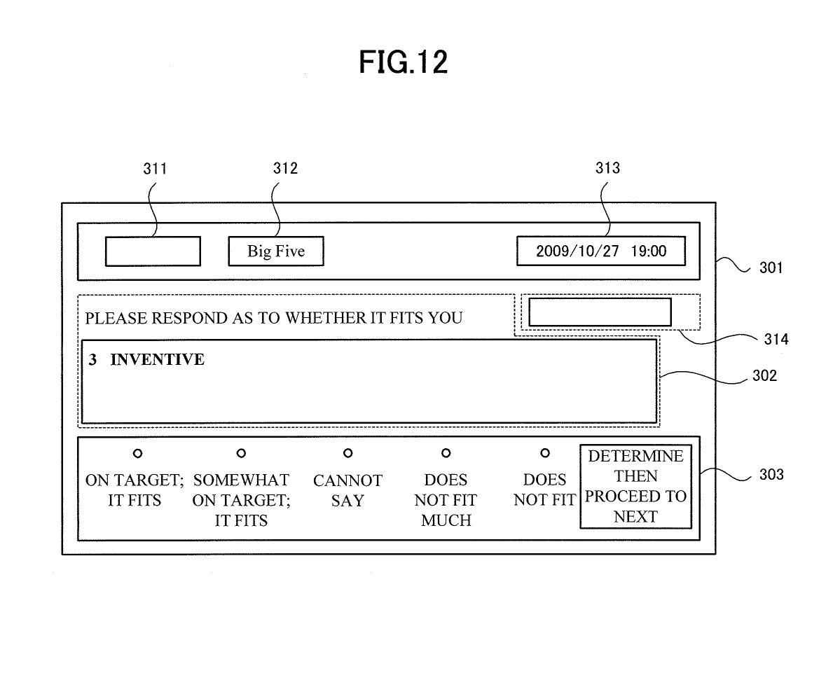

FIG. 12 is a diagram explaining an example of the output screen relating to embodiment 1. The output screen generator 16 generates an output screen based on GUI parts information selected by the output determination table created by the GUI parts selector 13 and the question information obtained from the question controller 11. In the example of FIG. 12, the output flag of the name information is 0, the output flag of the identification information is 1, the output flag of the date and time information is 1 and the output flag of the progress information is 0. Therefore, name information and progress information are not displayed in the name information display area 311 and progress information display area 314, and identification information “Big Five” and the date and time information “2009/10/27 19:00” are displayed in the identification information display area 312 and date and time information display area 313. In the question information display area 302, the question information content “Please respond as to whether it fits you.” and “3 inventive” are displayed. Furthermore, “3” of the contents of the question information is a question number. The question number is applied to question information in order of output by question controller 11. By this means, it is possible to discriminate questions which have been responded to from questions which have not been responded to and to determine the order of the questions. In addition, the progress information can be calculated such that, for example, as response situation of the survey composed of 50 questions, if the question number shows that the current question is the third question, 50 questions remain. In the response display area 303, is displayed, for the purpose of personalizing the responses, the five buttons “on target; it fits”, “somewhat on target; it fits”, “cannot say”, “does not fit much” and “does not fit”.

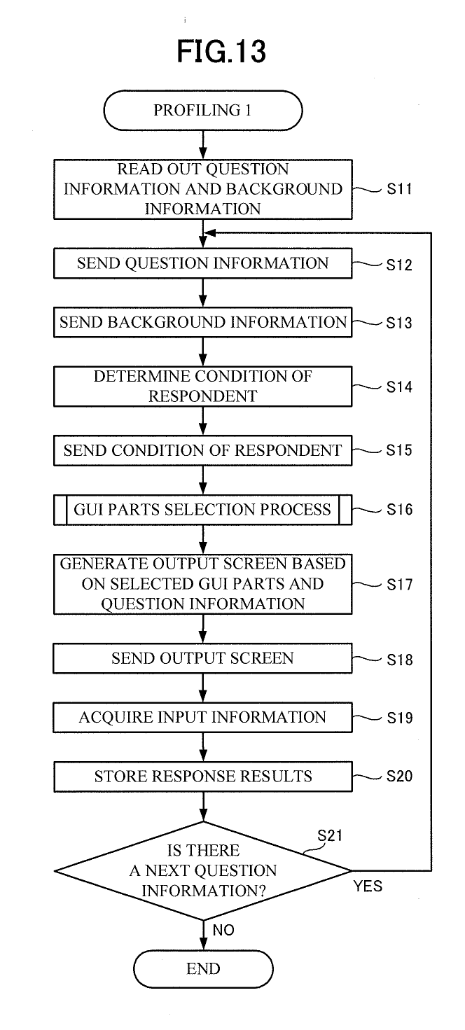

FIG. 13 is a flow chart example of profiling operation in the profiling device 1 relating to embodiment 1. The question controller 11 reads out the question information and background information output to the respondent, from the question/background storage 12 (step S11), and sends the question information for output among the read out question to the output screen generator 16 (step S12). In addition, the question controller 11 sends the background information corresponding to the output question information to the GUI parts selector 13 (step S13). On the other hand, the user determinator 15 determines the condition of the respondent based on the input information acquired by the information acquirer 17 (step S14), and sends the value Xn such as the degree of fatigue or the degree of stress to the GUI parts selector 13 as the condition of the respondent (step S15). The GUI parts selector 13 executes GUI parts selection process based on the background information received from the question controller 11 and the value Xn received from the user determinator 15 (step S16).

The output screen generator 16 generates the output screen 301 based on the GUI information that is selected by the GUI parts selector 13 in the GUI parts selection process and the question information obtained from the question controller 11 (step S17), and sends the output screen 301 to the respondent terminal 6 (step S18). The respondent views the output screen 301 displayed on the display 62 of the respondent terminal 6 and inputs the input information to the inputter 61. The information acquirer 17 acquires the input information from the respondent terminal 6 (step S19), and the response storage 19 stores the input information showing response results among the input information (step S20). The information acquirer 17 sends the input information necessary for determining the condition of the respondent among the input information to the user determinator 15. After step S20, the question controller 11 determines whether there is a next question (step S21). If next question information exists (step S21; YES), the profiling operation process returns to step S12, and the process of steps S12-S21 is repeated. If there is no next question information (step S21; YES), the profiling operation process is terminated.

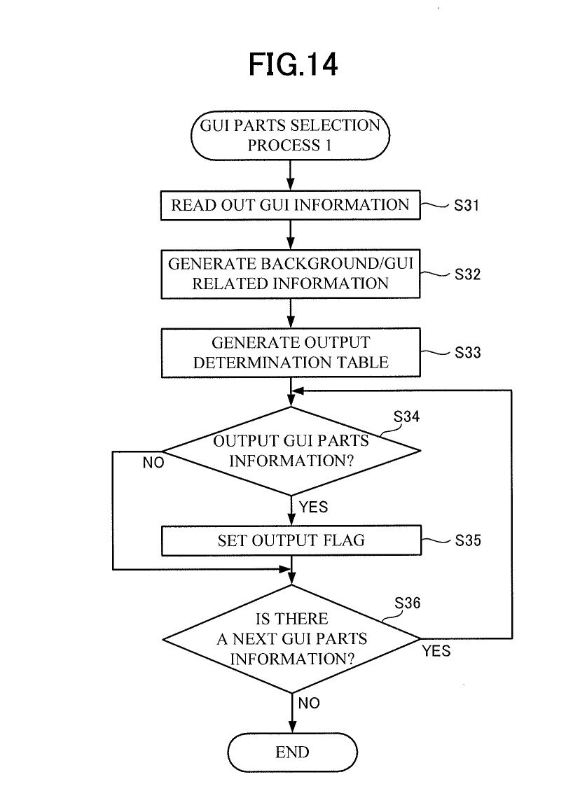

FIG. 14 is a flow chart showing an example of the GUI parts selection process of step S16 of FIG. 13, accomplished by the GUI parts selector 13 relating to embodiment 1. First of all, the GUI parts selector 13 reads out the GUI information from the GUI storage 14 (step S31). Next, the GUI parts selector 13 generates background/GUI related information based on the background information received from the question controller 11 and the GUI information read out from the GUI storage 14 (step S32). Also, the GUI parts selector 13 generates an output determination table based on the background/GUI related information and the condition of the respondent determined by the user determinator 15 (step S33), and determines whether to output each GUI parts information (step S34). If it is determined not to output the GUI parts information (step S34; NO), the GUI parts selector 13 determines whether there is a next GUI parts information (step S36). If there is a next GUI parts information (step S36; YES), the GUI parts selector 13 returns to step S34, and repeats steps S34-36. If there is no next GUI parts information (step S36; NO), the GUI parts selector 13 terminates the process.

On the other hand, if it is determined to output the GUI parts information (step S34; YES), the GUI parts selector 13 sets an output flag to the GUI parts information of the output determination table (step S35). Also, the GUI parts selector 13 determines whether there is a next GUI parts information (step S36). If there is a next GUI parts information (step S36; YES), the GUI parts selector 13 returns to step S34, and repeats steps S34-36. If it is determined that there is no next GUI parts information (step S36; NO), the GUI parts selector 13 terminates the process.

According to the profiling system 100 of the first embodiment explained above, the respondent can appropriately use a regularly-used PC, and an output screen which reduces the biases of the respondent by the GUI parts information displayed on the output screen can be provided to the respondent. By this means, the reduction of response accuracy attributable to the bias of the respondent at the time of response can be prevented. In addition, effects that can acquire highly accurate response results while minimizing less accurate response results can be expected by considering stimulation from the GUI parts information displayed on the output screen according to the respondent's conditions such as fatigue at the time of response.

### Embodiment 2

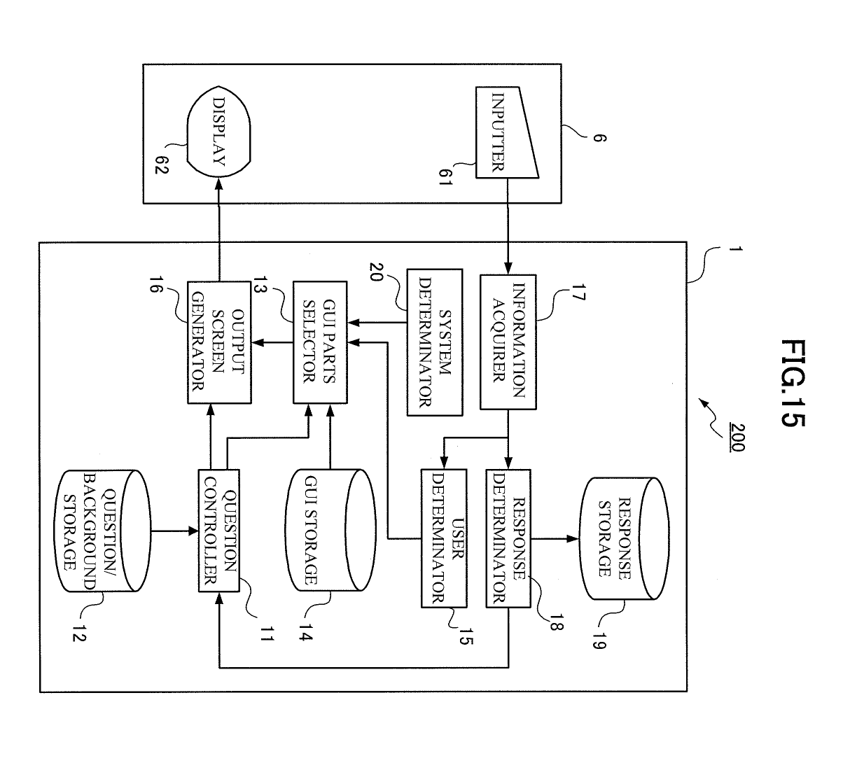

FIG. 15 is a block diagram showing an example of the composition of a profiling system relating to a second embodiment of the present invention. The profiling system 200 is a system in which a system determinator 20 is added to the profiling device 1 of the profiling system 100 relating to embodiment 1. In embodiment 2, the system determinator 20 sends to the GUI parts selector 13 an instruction for checking if there are any errors in the GUI parts information (hereafter referred to as a check instruction). For example, if the input information input by the respondent is stored in the response storage 19 as the GUI parts information such as the name of the respondent, the current date and time, or identification information of question information during output includes errors, the input information may be unusable as response data. Owing to this, it is desirable that the GUI parts information is accurate. Therefore, the system determinator 20 sends to the GUI parts selector 13 an instruction for checking if there are no errors in the GUI parts information, and functions to eliminate waste such that the question is pursued with the system information including errors. If there are no errors in the GUI parts information, the profiling system 200 functions in a manner such as that of the profiling system 100.

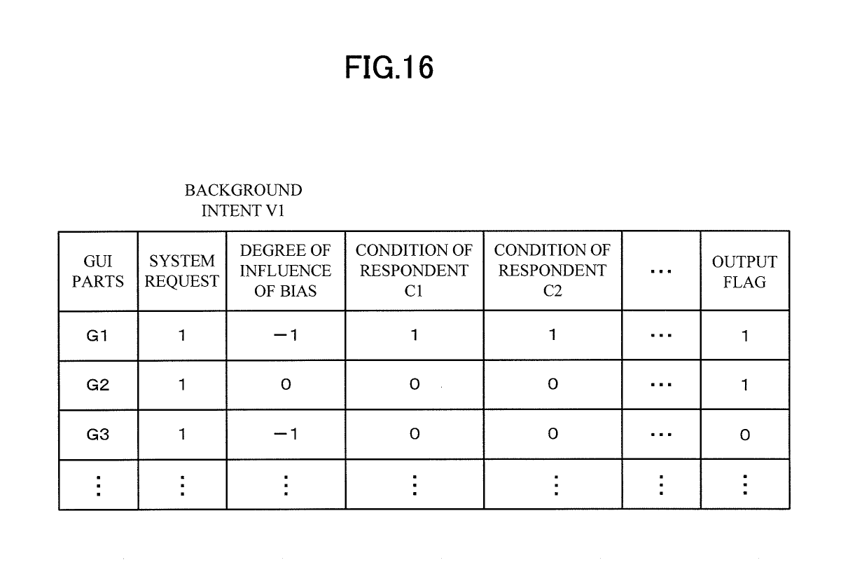

FIG. 16 is a diagram which explains the data composition of the output determination table created by the GUI parts selector 13 in embodiment 2. In The output determination table in embodiment 2, the item “system request” is added to the output determination table in the first embodiment (see FIG. 10). When the GUI parts selector 13 receives a check instruction from system determinator 20, the GUI parts selector 13 inputs 1 to the item “system request” of the output determination table. The GUI parts selector 13 surely inputs 1 to the item “output flag” and forces to display the GUI parts information if 1 is input to the item “system request” when the GUI parts selector 13 performs selection of the GUI parts information. The respondent checks whether the GUI parts information includes errors. If the GUI parts information includes no errors, the respondent inputs information showing that the GUI parts information includes no errors. If the GUI parts information includes errors, the respondent inputs the correct information.

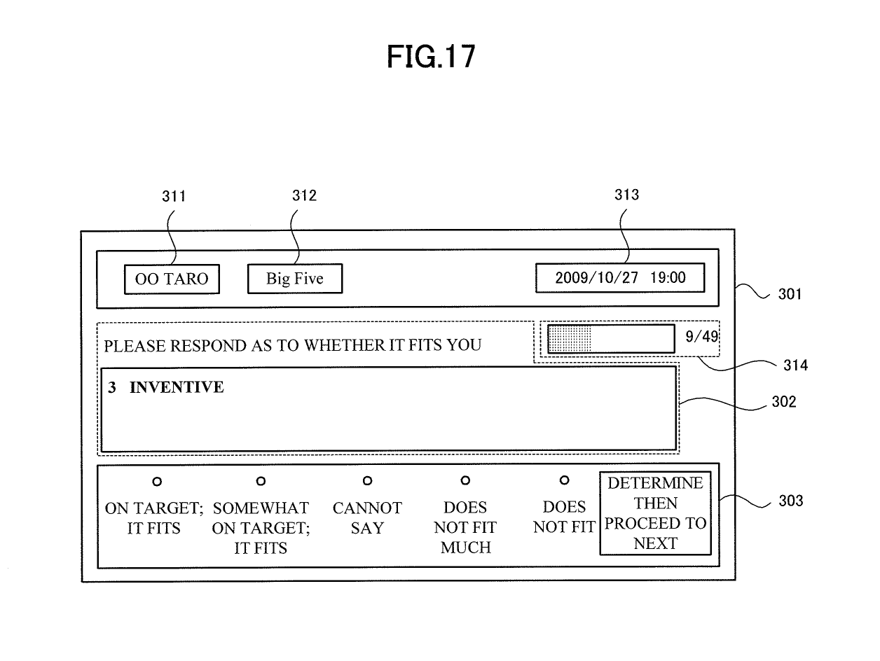

FIG. 17 is a diagram explaining an example of an output screen relating to embodiment 2. For example, at the time of commencing questioning, the system determinator 20 sends to the GUI parts selector 13 a check instruction concerning all of the GUI parts information selected by the GUI parts selector 13. The GUI parts selector 13 inputs 1 to the item “system request” of all of the GUI parts information. The output screen generator 16 presents the output screen 301 which displays all of the GUI parts information such as shown in FIG. 17 to the respondent. The respondent can check, concerning each GUI parts information, whether the respondent's name, identification information of the question information and system date and time during the current output are correct. When the respondent inputs information showing that the GUI parts information includes no errors, the inputter 61 of the respondent terminal 6 transmits it to the information acquirer 17 of the profiling device 1. By this means, the system determinator 20 sends information showing that there is no error in the GUI parts information to the GUI parts selector 13, and the GUI parts selector 13 changes the value of the item “system request” of the output determination table to 0. On the other hand, when the respondent determines that the presented GUI parts information includes errors and inputs correct GUI parts information, the inputter of the respondent terminal 6 transmits it to the information acquirer 17 of the profiling device 1. The system determinator 20 sends the correct GUI parts information to the GUI parts selector 13, and the GUI parts selector 13 corrects the GUI parts information, and changes the value of the item “system request” of the output determination table to 0.

Moreover, the system determinator 20 may send check instruction to the GUI parts selector 13 not only at the time of question commencement but also periodically. In addition, the system determinator 20 may also send check instruction for each GUI parts information. For example, the system determinator 20 may regularly send check instruction only concerning GUI parts information selected by the GUI parts selector 13, or may send check instruction only for name information and data and time information easily checked by the user.

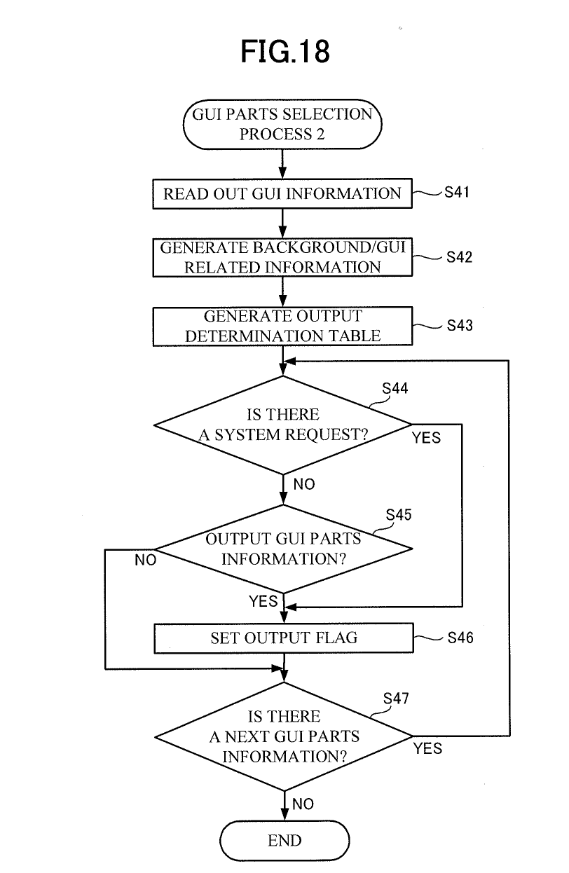

FIG. 18 is a flowchart showing an example of the GUI parts selection process performed by the GUI parts selector 13 relating to the second embodiment. First of all, the GUI parts selector 13 reads out the GUI information from the GUI storage 14 (step S41). Next, the GUI parts selector 13 generates background/GUI related information based on the background information received from the question controller 11 and the GUI information read out from the GUI storage 14 (step S42). The GUI parts selector 13 generates an output determination table based on the background/GUI related information and the condition of the respondent determined by the user determinator 15 (step S43). Next, the GUI parts selector 13 references the item “system request” concerning each GUI parts information of the output determination table, and determines if a system request exists (step S44). If there is a system request (step S44; YES), the GUI parts selector 13 sets an output flag to the GUI parts information (step S46). The GUI parts selector 13 determines whether next GUI parts information is present (step S47). Next, if the GUI part is present (step S47; YES), the GUI parts selector 13 returns to step S44, and repeats steps S44-47. If next GUI part is not present (step S47; NO), the GUI parts selector 13 terminates the process.

On the other hand, if there is no system request (step S44; NO), the GUI parts selector 13 determines whether to output the GUI parts information (step S45). If it is determined not to output the GUI parts information (step S45; NO), the GUI parts selector 13 determines whether next GUI parts information exists (step S47). If next GUI parts information exists (step S47; YES), the GUI parts selector 13 returns to step S44, and repeats steps S44-47. If no GUI part exists (step S47; NO), the GUI parts selector 13 terminates the process. If it is determined to output the GUI parts information (step S44; YES), the GUI parts selector 13 sets an output flag to the GUI parts information (step S46). The GUI parts selector 13 determines whether next GUI parts information exists (step S47). If next GUI parts information exists (step S47; YES), the GUI parts determinator 13 returns to step S44 and repeats steps S44-47. If no next GUI part exists (step S47; NO), the GUI parts selector 13 terminates the process.

According to the profiling system in embodiment 2 such as that described above, it is possible to eliminate waste such that the system is operated with erroneous GUI parts information and to lighten the burden of the respondent such as another response.

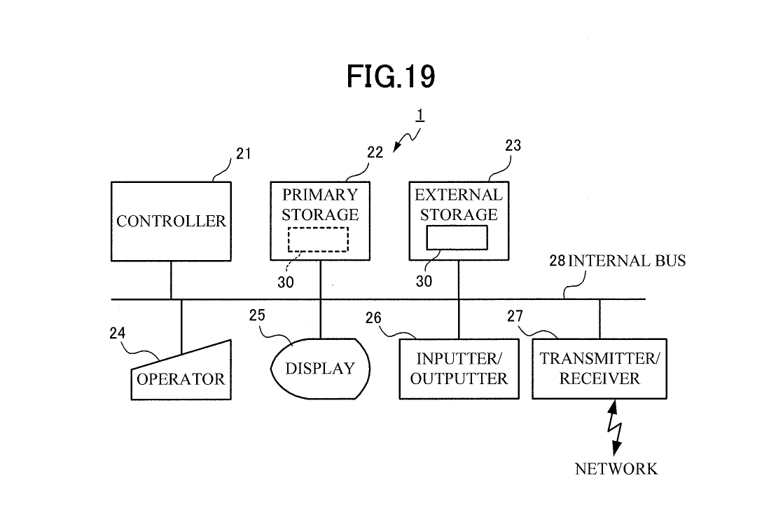

FIG. 19 is a block diagram showing an example of the hardware composition of the profiling device relating to embodiments of the present invention. The profiling device 1, as shown in FIG. 19, includes a controller 21, primary storage 22, external storage 23, operator 24, display 25, inputter/outputter 26 and transmitter/receiver 27. Each of the primary storage 22, external storage 23, operator 24, display 25, inputter/outputter 26 and transmitter/receiver 27 are connected to the controller 21 through an internal bus 28.

The controller 21 comprises a CPU (Central Processing Unit) and the like. The controller 21 executes the processes of the question controller 11, GUI parts selector 13, user determinator 15, output screen generator 16, information acquirer 17, response determinator 18 and system determinator 20 of the profiling device 1 under a control program 30 stored in the external storage 23.

The primary storage 22 comprises a RAM (Random-Access Memory) and the like. The primary storage 22 loads the control program 30 stored in the external storage 23 and is used as a working area of the controller 21.

The external storage 23 comprises nonvolatile memory such as a flash memory, a hard disk, DVD-RAM (Digital Versatile Disc Random-Access Memory), DVD-RW (Digital versatile Disc Rewritable). The external storage 23 pre-stores a program for working the controller 21 to perform the process of profiling device 1. In addition, the external storage 23 supply data stored by the program to the controller 21 and stores data supplied from the controller 21. The question/background storage 12, GUI storage 14 and response storage 19 of the profiling device 1 are composed of the external storage 23.

The operator 24 comprises a keyboard, a pointing device such as a mouse, and an interface device connecting the keyboard and the pointing device to the internal bus 28. When the question creator inputs question text or when the GUI parts selection threshold is set or the like, an instruction is supplied to the controller 21 through the operator 24. In a composition shown in FIGS. 1 and 15 where the respondent terminal 6 is included in the profiling device 1, the operator 24 can be the inputter 61.

The display 25 comprises a CRT (Cathode Ray Tube), an LCD (Liquid Crystal Display) and the like. When the question creator inputs question text or when the GUI parts selection threshold is set, the display 25 displays the operating screen. In a composition shown in FIG. 1 or 15 where the respondent terminal 6 is included in the profiling device 1, the display 25 can be the display 62.

The inputter/outputter 26 comprises a serial interface and/or a parallel interface. If the respondent terminal 6 is an attached device to the profiling device 1, the inputter/outputter 26 are connected to the respondent terminal 6.

The transmitter/receiver 27 comprises a net terminal device and/or a wireless communication device connecting to a network, a serial interface connecting to them, and/or a LAN (local area network) interface. The transmitter/receiver 27 connects to the respondent terminal 6 through a network.

The processes of the question controller 11, GUI part selector 13, user determinator 15, output screen generator 16, information acquirer 17, response determinator 18 and system determinator 20 shown in FIGS. 1 and 15 are executed by processes of the control program 30 using the controller 21, primary storage 22, external storage 23, operator 14, display 25, input/output 26 and transmitter/receiver 27 as resources.

Other than that, the composition of the hardware or flowcharts described above are exemplary, and they may be arbitrarily changed or modified.

The main part, which comprises the question controller 11, GUI parts selector 13, user determinator 15, output screen generator 16, information acquirer 17, response determinator 18 and system determinator 20 and the like, and performs profiling processes, can be realized by using an ordinary computer system without the use of a dedicated system. For example, a computer program for executing the operations described above may be stored in a computer readable storage medium (flexible disk, CD-ROM, DVD-ROM or the like) and distributed. The profiling systems 100 and 200 executing the processes described above may be composed by installing the computer program in a computer. In addition, the computer program may also be stored in a storage device included in a server device on a communication network such as the Internet. The ordinary computer system may download the computer program from the storage device to configure the profiling systems 100 and 200.

In addition, in executing the functions of the profiling systems 100 and 200 by allocating the OS (operating system) and application programs or by cooperation between the OS and application system, only the application program part may be stored in a storage medium or storage device.

In addition, it is also possible to place the computer program on a carrier wave, and transmit them through a communication network. For example, the computer program may be posted on a communications network BBS (bulletin board system), and transmitted through a network. The profiling systems 100 and 200 may also be composed so as to perform the processes by initiating the computer program, and executing the computer program in a similar manner to another application program under OS control.

Part or all of the exemplary embodiments disclosed above can be described as, but not limited to, the following supplementary notes. Furthermore, the present invention is not limited to the above embodiments or to the content appended below. Various other embodiments or corresponding examples can also be achieved by one skilled in the art based on the contents of the above embodiments or below listed contents and be included within the invention so long as they are not removed from the accuracy or exceed the parameters of the present invention.

(Supplementary Note 1)

A profiling system including:

question storage means which stores question information showing a question for examining a nature of a respondent and background information showing a relationship between a background intent showing the nature and a bias which exerts an influence on responses of the respondent;

GUI storage means which stores GUI information showing a relationship between GUI parts which are elements composing an output screen and the bias;

selection means which, based on the background information and the GUI information, calculates a degree of influence of the bias by pairing the background intent with the GUI parts, and which selects GUI parts information where the degree of influence exceeds a threshold value; and

presentation means which creates the output screen based on the question information and the GUI parts information selected by the selection means to present the output screen to the respondent.

(Supplementary Note 2)

The profiling system according to Supplementary note 1, further including information acquisition means which acquires input information input by the respondent; and

determination means which converts the input information into a value representing a condition of the respondent, using predetermined standards based on the input information, wherein

the selection means selects GUI parts information which has a total value that exceeds the threshold value, the total value being determined by combining the degree of influence of bias and the value representing the condition of the respondent.

(Supplementary Note 3)

The profiling system according to Supplementary note 2, wherein the information acquisition means further acquires biometric information of the respondent, and

the determination means, based on the input information and/or the biometric information, converts the input information and/or the biometric information into values representing the condition of the respondent according to the predetermined standards.

(Supplementary Note 4)

The profiling system according to any one of Supplementary note 1-3, further including instruction means which outputs a check instruction which checks if there is an error in the GUI parts information, wherein

the selection means forcibly selects the GUI parts information if the instruction means outputs the check instruction.

(Supplementary Note 5)

A profiling method, which is a profiling method for a profiling system which presents problems to a respondent, including:

a selection step which, based on background information showing a relationship between a background intent showing a nature of a respondent examined by the question and a bias exerting an influence on a response of the respondent, the background information being stored by question storage means, and GUI information showing a relationship between GUI parts which are elements composing an output screen and the bias, the GUI information being stored by GUI storage means, calculates a degree of influence of the bias by pairing background the intent and the GUI parts and selects GUI parts information which has the degree of influence that exceeds a threshold value; and

a presentation step which, based on question information showing the questions and the GUI parts information selected in the selection step, generates the output screen and presents the output screen to the respondent.

(Supplementary Note 6)

The profiling method according to Supplementary note 5, further including an information acquisition step which acquires input information input by the respondent; and

a determination step which converts the input information into a value representing a condition of the respondent using predetermined standards based on the input information, wherein

the selection step selects GUI parts information which has a total value that exceeds the threshold value, the total value being determined by combining the degree of influence of bias and the value representing the condition of the respondent.

(Supplementary Note 7)

The profiling method according to Supplementary note 6, wherein the information acquisition step further acquires biometric information of the respondent; and

the determination step converts the input information and/or the biometric information into a value representing the condition of the respondent using the predetermined standards based on the input information and/or the biometric information.

(Supplementary Note 8)

The profiling method according to any one of Supplementary note 5-7, further including an instruction step which outputs a check instruction which checks whether there is an error in the GUI parts information, wherein

the selection step forcibly selects the GUI parts information if the check instruction is output in the instruction step.

(Supplementary Note 9)

A computer-readable recording medium that stores a program for causing a computer to perform:

a selection step which, based on background information showing a relationship between a background intent showing a nature of a respondent examined by the question and a bias exerting an influence on a response of the respondent, the background information being stored by question storage means, and GUI information showing a relationship between GUI parts which are elements composing an output screen and the bias, the GUI information being stored by GUI storage means, calculates a degree of influence of the bias by pairing background the intent and the GUI parts and selects GUI parts information which has the degree of influence that exceeds a threshold value; and

a presentation step which, based on question information showing the questions and the GUI parts information selected in the selection step, generates the output screen and presents the output screen to the respondent.

The present invention is based on Patent Application No. 2010-055978 filed in Japan Mar. 12, 2010; and incorporates by reference the Specification, Scope of the Claims, and all of the Drawings.

### DESCRIPTION OF REFERENCE NUMERALS

1 Profiling device
6 Respondent terminal
11 Question controller
12 Questions/background storage
13 GUI parts selector
14 GUI storage
15 User determinator
16 Output screen generator
17 Information acquirer
18 Respondent determinator
19 Response storage
20 System determinator
21 Controller
22 Primary storage
23 External storage
24 Operator
25 Display
26 Inputter/Outputter
27 Transmitter/receiver
28 Internal bus
30 Control program
61 Inputter
62 Display
100, 200 Profiling system
301 Output screen
302 Question information display area
303 Response display area
311 Identity information display area
312 Discrimination information display area
313 Date and time information display area
314 Progress information display area

1. A profiling system comprising:
question storage unit which stores question information showing a question for examining a nature of a respondent and background information showing a relationship between a background intent showing the nature and a bias which exerts an influence on responses of the respondent;
GUI storage unit which stores GUI information showing a relationship between GUI parts which are elements composing an output screen and the bias;
selection unit which, based on the background information and the GUI information, calculates a degree of influence of the bias by pairing the background intent with the GUI parts, and which selects GUI parts information where the degree of influence exceeds a threshold value; and
presentation unit which creates the output screen based on the question information and the GUI parts information selected by the selection unit to present the output screen to the respondent.

2. The profiling system according to claim 1, further comprising:
information acquisition unit which acquires input information input by the respondent; and
determination unit which converts the input information into a value representing a condition of the respondent, using predetermined standards based on the input information, wherein
the selection unit selects GUI parts information which has a total value that exceeds the threshold value, the total value being determined by combining the degree of influence of bias and the value representing the condition of the respondent.

3. The profiling system according to claim 2, wherein
the information acquisition unit further acquires biometric information of the respondent, and
the determination unit, based on the input information and/or the biometric information, converts the input information and/or the biometric information into values representing the condition of the respondent according to the predetermined standards.

4. The profiling system according to claim 1, further comprising:
instruction unit which outputs a check instruction which checks if there is an error in the GUI parts information, wherein
the selection unit forcibly selects the GUI parts information if the instruction unit outputs the check instruction.

5. A profiling method performed by a profiling system whereby a question is presented to a respondent, the method comprising:
a selection step which, based on background information showing a relationship between a background intent showing a nature of a respondent examined by the question and a bias exerting an influence on a response of the respondent, the background information being stored by question storage unit, and GUI information showing a relationship between GUI parts which are elements composing an output screen and the bias, the GUI information being stored by GUI storage unit, calculates a degree of influence of the bias by pairing background the intent and the GUI parts and selects GUI parts information which has the degree of influence that exceeds a threshold value; and
a presentation step which, based on question information showing the questions and the GUI parts information selected in the selection step, generates the output screen and presents the output screen to the respondent.

6. The profiling method according to claim 5, further comprising:
an information acquisition step which acquires input information input by the respondent; and
a determination step which converts the input information into a value representing a condition of the respondent using predetermined standards based on the input information, wherein
the selection step selects GUI parts information which has a total value that exceeds the threshold value, the total value being determined by combining the degree of influence of bias and the value representing the condition of the respondent.

7. The profiling method according to claim 6, wherein
the information acquisition step further acquires biometric information of the respondent; and
the determination step converts the input information and/or the biometric information into a value representing the condition of the respondent using the predetermined standards based on the input information and/or the biometric information.

8. The profiling method according to claim 5, further comprising:
an instruction step which outputs a check instruction which checks whether there is an error in the GUI parts information, wherein
the selection step forcibly selects the GUI parts information if the check instruction is output in the instruction step.

9. A computer-readable recording medium that stores a program for causing a computer to perform
a selection step which, based on background information showing a relationship between a background intent showing a nature of a respondent examined by the question and a bias exerting an influence on a response of the respondent, the background information being stored by question storage unit, and GUI information showing a relationship between GUI parts which are elements composing an output screen and the bias, the GUI information being stored by GUI storage unit, calculates a degree of influence of the bias by pairing background the intent and the GUI parts and selects GUI parts information which has the degree of influence that exceeds a threshold value; and
a presentation step which, based on question information showing the questions and the GUI parts information selected in the selection step, generates the output screen and presents the output screen to the respondent.
